(19) United States
(12) Patent Application Publication
(10) Pub. No.: US 2019/0149740 A1
(43) Pub. Date: May 16, 2019

(54) Image tracking device

(71) Applicant: Yu Chieh Cheng, New Teipei City (TW)

(72) Inventor: Yu Chieh Cheng, New Teipei City (TW)

(21) Appl. No.: 16/133,729

(22) Filed: Sep. 18, 2018

(30) Foreign Application Priority Data
Nov. 13, 2017 (TW) 106216862

(51) Int. Cl. H04N 5/232; G06T 7/73; G06T 7/20

(52) U.S. Cl. CPC H04N 5/23299; G06T 7/20; G06T 7/73

(57) ABSTRACT

An image tracking device is applied to carry an electronic device and contains: an image capture unit, a processor, and a drive unit. The image capture unit is configured to capture images of objects and to produce data signals corresponding to the images. The processor is coupled to the image capture unit and is configured to process the data signals of the images from the image capture unit and to produce a driving signal. The drive unit is coupled to the processor and is configured to receive the driving signal from the processor so as to adjust an angle and a direction of the electronic device.

### FIELD OF THE INVENTION

The present invention relates to an image tracking device which is applied to carry an electronic device.

### BACKGROUND OF THE INVENTION

A conventional image tracking device is a camera configured to track objects, but the camera costs expensively has slow tracking speed and processing time of images because of high image quality.

A conventional smart phone is employed to take photographs, but a photographing range is limited. Furthermore, the smart phone cannot measure human's body automatically.

The present invention has arisen to mitigate and/or obviate the afore-described disadvantages.

### SUMMARY OF THE INVENTION

The primary aspect of the present invention is to provide an image tracking device which is configured to carry an electronic device so as to control photography or an angle and a direction of the electronic device.

To obtain the above-mentioned aspect, an image tracking device provided by the present invention contains: an image capture unit, a processor, and a drive unit.

The image capture unit is configured to capture images of objects and to produce data signals corresponding to the images.

The processor is coupled to the image capture unit and is configured to process the data signals of the images from the image capture unit and to produce a driving signal.

The drive unit is coupled to the processor and is configured to receive the driving signal from the processor so as to adjust an angle and a direction of the electronic device.

### BRIEF DESCRIPTION OF THE DRAWINGS

FIG. 1 is a schematic view showing the assembly of an image tracking device according to a preferred embodiment of the present invention.

FIG. 2 is a flow chart showing the operation of the image tracking device according to the preferred embodiment of the present invention.

FIG. 3A is a schematic view showing the operation of the image tracking device according to the preferred embodiment of the present invention.

FIG. 3B is another schematic view showing the operation of the image tracking device according to the preferred embodiment of the present invention.

### DETAILED DESCRIPTION OF THE FIRST EMBODIMENTS

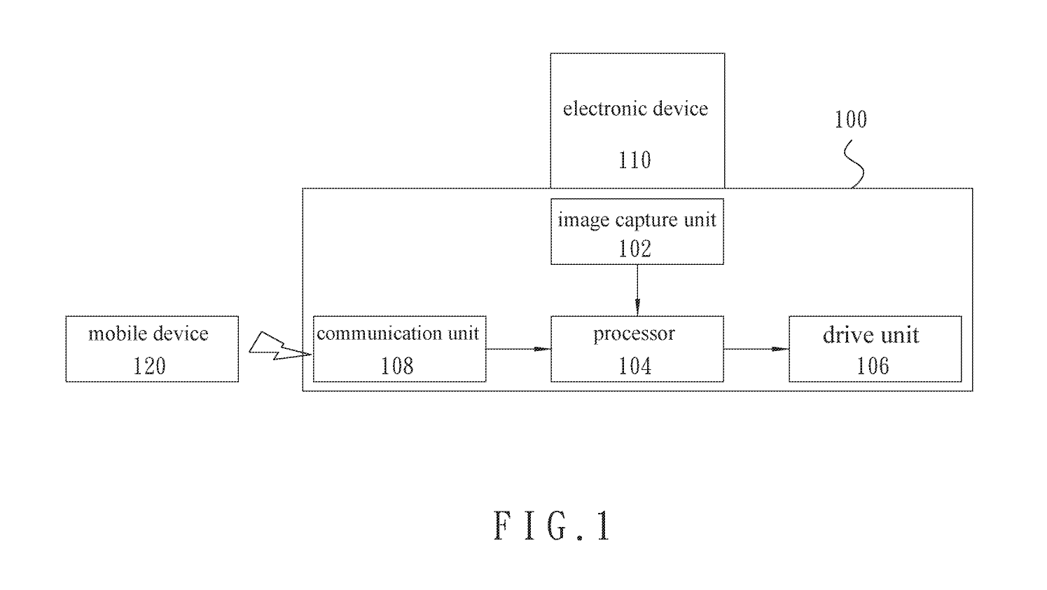

With reference to FIG. 1, an image tracking device 100 according to a preferred embodiment of the present invention comprises: an image capture unit 102, a processor 104, a drive unit 106, and a communication unit 108, wherein the processor 104 is coupled to the image capture unit 102, the drive unit 106, and the communication unit 108.

The image tracking device 100 is configured to carry an electronic device 110 so as to control photography or an angle and a direction of the electronic device 110.

The image tracking device 100 is coupled with a mobile device 120 via a communication unit 108, and the mobile device 120 sets multiple parameters of the image tracking device 100 via the communication unit 108, wherein the multiple parameters are capable of tracking various objects.

The image capture unit 102 is configured to capture images of objects, to produce data signals corresponding to the images, and to send the images toward the processor 104, wherein the objects are any one of human face, spherical objects, and license plates. The image capture unit 102 captures the images of the objects by using photographic lens. In another embodiment, the image capture unit 102 captures the images of the objects by ways of circuit components.

The processor 104 is configured to process the data signals of the images from the image capture unit 102 and to judge whether a central point of each object is located within a central zone of each of the images corresponding to each data signal of each image, and the processor 104 is configured to send a driving signal to the drive unit 106, thus driving the image tracking device 100. In other words, the processor 104 is configured to judge whether location data of the data signals is more than a critical value, when the location data is more than the critical value, the driving signal corresponding to the location data produces. In another embodiment, the processor 104 is a microprocessor or other circuit elements.

The drive unit 106 is configured to receive the driving signal from the processor 104 so as to move or rotate the electronic device 110, hence the photography or the angle and the direction of the electronic device 110 are changeable so that the electronic device 110 keeps photographing or detecting the objects. The drive unit 106 is driven by a motor or other circuit elements configured to control the angle and the direction of the electronic device 110.

The communication unit 108 is configured to receive multiple setting signals of the mobile device 120 and to send the multiple setting signals toward the processor 104, thus setting the multiple parameters of the image tracking device 100. The multiple setting signals contain feature tracking of the objects so that the processor 104 judges whether the objects are located within the images of the objects captured by the image capture unit 102 based on the feature tracking of the objects. The communication unit 108 communicates with the image capture unit 102 in a Bluetooth transmission manner. In another embodiment, the communication unit 108 is a communication chip or other circuit elements which communicate with the image capture unit 102.

Referring to FIG. 1, the electronic device 110 is configured to capture data values of the objects, wherein the data values are the images or temperatures individually. The electronic device 110 is any one of a smart phone, a camera, and a temperature sensor. In another embodiment, various electronic devices with tracking functions are provided.

As shown in FIG. 1, the mobile device 120 is configured to send the multiple setting signals to the communication unit 108. The mobile device 120 executes initial setting of the image tracking device 100 via application (APP) or graphical user interface (GUI), wherein the initial setting contains setting features of the objects so that the image tracking device 100 positions the central point of each object to track the objects. The mobile device 120 is any one of a smart phone, a tablet computer, a laptop, and other electronic devices which wirelessly communicate with the image tracking device 100.

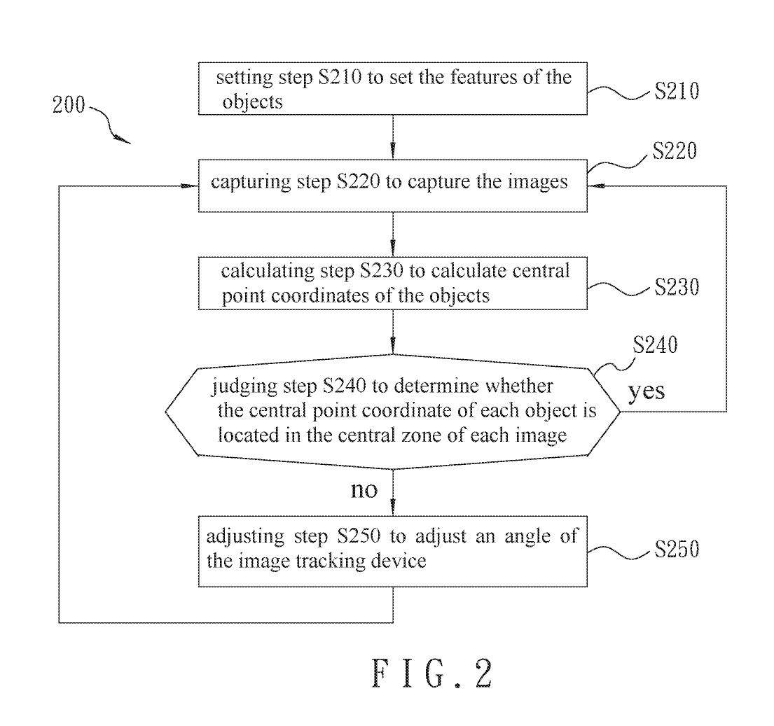

With reference to FIG. 2, an operating method 200 of the image tracking device 100 comprises:

a setting step S210 to set the features of the objects, wherein the mobile device 120 sets the features of the objects tracked by the image tracking device 100 via APP or GUI so that the processor 104 distinguishes locations of the objects in the images, for example, when the mobile device 120 sets the features of human faces, the processor 104 judges locations of the human faces in the images via a facial recognition system, wherein when the features of the objects set by the mobile device 120 are the spherical objects respectively, the processor 104 distinguishes locations of the spherical objects in the images individually after distinguishing circular objects in the images;

a capturing step S220 to capture the images, wherein each image is captured by the image capture unit 102 so as to produce an image capturing signal, and the processor 104 processes each image and requests the image capture unit 102 to transmit a next image, thus tracking each image immediately. In another embodiment, a resolution of each image captured by the image capture unit 102 is less than each image photographed by the smart phone because when the resolution is small, a memory capacity of the image tracking device 100 is not occupied and a production cost of the image tracking device 100 is reduced greatly.

In another embodiment, the resolution of each image captured by the image capture unit 102 is less than 640 pixels×480 pixels, and a capturing speed of the image capture unit 102 is less than or is equal to twenty images/per second.

In the capturing step S220, the image capture unit 102 is set to capture grayscale images, and each of the grayscale images corresponding to a grayscale capturing signal is stored in a memory (not shown) of the processor 104, because the grayscale images help the processor 104 to distinguish the locations of the objects.

The operating method 200 of the image tracking device 100 further comprises:

a calculating step S230 to calculate central point coordinates of the objects, wherein the processor 104 calculates the central point coordinates of the objects in the grayscale images according to the features of the objects. In another embodiment, the features of the objects (such as hats, the human faces, the spherical objects, or the license plates.) are graded based on recognition training levels of the objects and are recorded in the APP by using algorithms, and the images are compared by using a matrix calculation (i.e., a calculation of integral image) in a comparison sub-step and are distinguished in a distinguishing sub-step so as to judge the objects in the images, then the objects are marked into a rectangular virtual framework and acquires the central point of each object so as to represent the central point coordinates of the objects. It is to be note that the algorithm is Haar Cascade or other algorithms. In another embodiment, the features of the objects contain edge features, linear features, center features, diagonal features, or other features, etc.

The operating method 200 of the image tracking device 100 further comprises:

a judging step S240 to determine whether the central point coordinate of each object is located in the central zone of each image, and the processor 104 acquires the central point coordinates of the objects from the memory (not shown) in the calculating step S230 so as to calculate whether the central point coordinates of the objects in the calculating step S230 are included within central areas of the images captured in the capturing step S220 respectively, wherein the central areas of the images of the capturing step S220 are square boxes of centers of the images of the capturing step S220 individually.

Furthermore, the judging step S240 is applied to determine whether proportions of the central areas of the images captured in the capturing step S220 are less than the critical value. When the proportions of the central areas of the images are less than the critical value, it denoted that the objects are located over capture ranges of the images respectively. In another embodiment, the critical value is 50% or other percentages.

The operating method 200 of the image tracking device 100 further comprises:

an adjusting step S250 to adjust an angle of the image tracking device 100 so that the central point coordinates of the objects are located within the central areas of the images respectively, wherein the processor 104 transmits the driving signal to the drive unit 106 so as to adjust the angle of the image tracking device 100 and to move central points of the images toward the central point coordinates of the objects respectively. After adjusting the angle of the image tracking device 100, the image tracking device 100 drives the electronic device 110 to rotate so that a central point of the electronic device 110 is adjustable to align with the objects.

In another embodiment, after executing the adjusting step S250, the capturing step S220, the calculating step S230, and the judging step S240 are executed once more, thus repeating the adjusting step S250, the capturing step S220, the calculating step S230, and the judging step S240 to track the objects immediately.

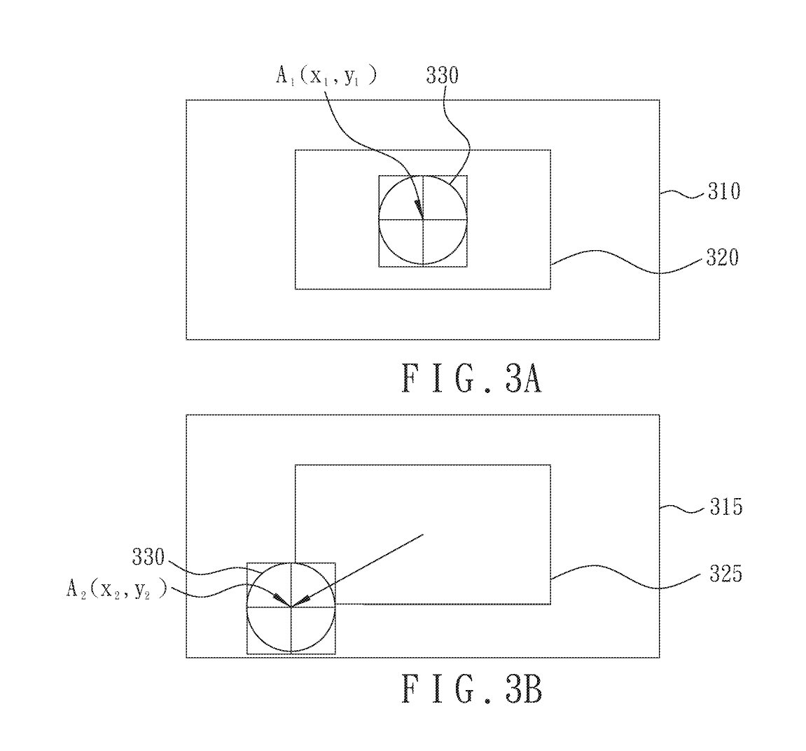

As illustrated in FIG. 3A, a first grayscale image 310 is obtained at a first time point t1 after being calculated, wherein a first central area 320 is located within the first grayscale images 310, and the central point of the object 330 is A1 (x1, y1). As shown in FIG. 3B, a second grayscale image 315 is obtained at a second time point t2 (wherein the second time point t2>the first time point t1) after being calculated, wherein a second central area 325 is located within the second grayscale image 315, and the central point of the object 330 is A2 (x2, y2), wherein the second central area 325 located in the first grayscale image 310 is identical to the first central area 320 located in the second grayscale image 315.

With reference to FIGS. 3A and 3B, when the central point of the object 330 is calculated at the second time point t2 by the processor 104 to be A2 (x2, y2) different from the first central point A1 (x1, y1) and beyond the second central area 325, a driving signal is produced to the drive unit 106 so that the image tracking device 100 is driven by the drive unit 106 to move or rotate toward the second central point A2 (x2, y2), thus rotating the electronic device 110 to align with the object.

In application, the image tracking device 100 is operated in live video to track a temperature of a patient or to chase a specific object. In the live video, the smart phone or the tablet computer is erected on the image tracking device 100 so that the angle of the smart phone or the tablet computer is not manually controlled by the user. In other words, the smart phone or the tablet computer is in alignment with the human face automatically so as to have smooth live broadcast.

When tracking the temperature of the patient, the temperature sensor is mounted on the image tracking device 100 so as to chase a position of the patient and to measure the temperature immediately.

When chasing the specific object (such as the spherical object or the license plate), the camera is fixed on the image tracking device 100 so as to chase the specific object automatically.

Accordingly, the image tracking device 100 is capable of carrying the electronic device (such as the smart phone or the temperature sensor) so as to photograph or detect the objects.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. An image tracking device being applied to carry an electronic device and comprising:
an image capture unit configured to capture images of objects and to produce data signals corresponding to the images;
a processor coupled to the image capture unit and configured to process the data signals of the images from the image capture unit and to produce a driving signal; and
a drive unit coupled to the processor and configured to receive the driving signal from the processor so as to adjust an angle and a direction of the electronic device.

2. The image tracking device as claimed in claim 1, wherein a capturing speed of the image capture unit is less than twenty images/per second.

3. The image tracking device as claimed in claim 1, wherein the processor is configured to judge whether location data of the data signals is more than a critical value, when the location data is more than the critical value, the driving signal corresponding to the location data produces.

4. The image tracking device as claimed in claim 3, wherein the processor is configured to acquire the location data of the objects based on features of the objects.

5. The image tracking device as claimed in claim 1, wherein the processor is configured to compare a coordinate of the data signal with a square box of a center of each image, wherein when the coordinate of the data signal is over the square box, the driving signal corresponding to the coordinate produces.

6. The image tracking device as claimed in claim 1, wherein the drive unit is configured to drive a central point of the image tracking device to align with a coordinate corresponding to the driving signal.

7. The image tracking device as claimed in claim 1, wherein the driving signal drives the image tracking device to rotate randomly.

8. The image tracking device as claimed in claim 1 further comprising a communication unit coupled to the processor, wherein the communication unit is configured to receive multiple setting signals of a mobile device and to send the multiple setting signals toward the processor, thus setting feature tracking of the objects.

9. The image tracking device as claimed in claim 8, wherein the processor is configured to distinguish the objects in the images respectively corresponding to the data signals based on the feature tracking of the objects.

10. The image tracking device as claimed in claim 8, wherein the communication unit communicates with the mobile unit in a Bluetooth transmission manner.
